(19) United States
(12) Patent Application Publication
(10) Pub. No.: US 2026/0081427 A1
(43) Pub. Date: Mar. 19, 2026

(54) ENERGY STORAGE SYSTEM FOR SUPPLEMENTAL SUPPLY TO ELECTRICAL TRANSMISSION AND DISTRIBUTION SYSTEM WITH INTEGRATED LOAD MANAGEMENT

(71) Applicant: Watershed Geosynthetics, LLC, Alpharetta, GA (US)

(72) Inventors: S. Kyle Ehman, Milton, GA (US); Michael R. Ayers, Johns Creek, GA (US)

(73) Assignee: Watershed Geosynthetics, LLC, Alpharetta, GA (US)

(21) Appl. No.: 19/399,256

(22) Filed: Nov. 24, 2025

Related U.S. Application Data
(63) Continuation-in-part of application No. 17/923,308, now Pat. No. 12,483,033.
(60) Provisional application No. 63/031,901, filed on May 29, 2020.
(60) Provisional application No. 63/033,648, filed on Jun. 2, 2020.

(51) Int. Cl. H02J 3/28; H02J 3/01; H02J 3/38

(52) U.S. Cl. CPC H02J 3/28; H02J 3/01; H02J 3/381; H02J 2101/24

(57) ABSTRACT

A local controller for supplying a supplemental electrical current to an electrical grid, based on a supply demand communicated by an electrical grid demand controller, the electrical current generated by an energy storage system using a heat transfer fluid at a first temperature and an injection liquid at a second temperature for phase change in a nozzle that ejects accelerated gas and HTF for mechanical work to operate a generator, and alternatively a plurality of solar photovoltaic modules exposed to ambient light for selectively heating the heat transfer fluid or for storing in a battery bank, for selective supply of the generated electrical current for heating the HTF, for storage in the battery bank, and for supply to the electrical grid, thereby managing the generation, storage, and supply of electrical current from the energy storage system and/or the solar photovoltaic modules and battery bank. A method of supplying supplemental electrical current to an electrical grid servicing load center using an energy storage system and optionally a solar-energy electricity generation system is disclosed.

### TECHNICAL FIELD

The present invention relates to electrical energy generation systems that supply electrical current to electricity transmission and distribution systems. More particularly, the present invention relates to an electrical generation system with integrated load management for managing the generation, storage, and provision from an energy storage system of a supplemental supply of electricity to the electricity transmission and distribution system.

### BACKGROUND OF THE INVENTION

Electricity generation, transmission, and distribution involve interconnected networks or grids, of electricity generation stations, long distance transmission power lines, and local distribution power lines that supply electrical current to load centers. Electricity generation is generally most economical at low voltages produced by large megawatt-capacity power plants. These plants often are constructed at rural areas remote from towns and cities. Substations equipped with power transformers receive the low voltage power and step-up the voltage to a higher voltage, and then communicates the high voltage electrical current through long distance transmission lines to local area distribution grids that step-down the voltage and connect to load centers that use the electrical current. Prior to reaching the load centers, such as homes, factories, and businesses, the high voltage electrical passes through step-down transformers for providing lower voltage electricity that communicates through distribution wires to the load centers.

While large-capacity electricity generation power plants (typically, 800 megawatt (fossil fuel plants) to 2200 megawatt (nuclear fuel plants)) supply electricity to the transmission and distribution grid, there is continuing and growing interest in alternative fuel electricity-generation systems. These alternative fuel system particularly include renewal resource fuel such as water, wind, and solar. Pumped water systems have been developed for supplement of electricity into the grid to meet peak demand by load centers. Pumps operate at off-peak time to transfer water from a first reservoir to a second reservoir at a higher elevation. During peak demand periods, the water flows from the second reservoir to the first reservoir passing through turbines for generating electricity and supply into the grid for meeting peak demand.

Wind turbines rely on wind power for turning blades and generating electricity with a renewable resource. Such devices however have drawbacks including danger to birds, blade operation noise, unattractive towers dotting the landscape, and a need to have expectation of reliable blowing winds that limits available operational sites.

Solar photovoltaic systems occupy large areas of ground and generate electricity during daylight hours for supplemental supply into the electrical grid. Closed landfills and laydown areas at traditional power generation plants offer large-area sites suitable for solar photovoltaic sites. The industry however includes small capacity systems for supplying electricity to individual homes and businesses with roof-top mounted photovoltaic modules. These however still require connection to the grid for nighttime power and excess demand supply during daylight. Thus, a drawback to small-capacity solar photovoltaic systems is the need to balance generation with demand and grid operating parameters. Solar generation at traditional power plants have the advantage of being in close proximity to substation transfer into the electrical grid, but small capacity sites often are remote from industry grid connections and unused solar capacity may be lost. While battery storage provides temporary holding of generated electricity, cost and space requirements limit the usefulness and solar suffers from “use or lose” capacity issues. The alternative sources of electricity have deficiencies in meeting time-of-day peak demands, for example, mid-afternoon demand increases for use of air conditioning or heating as persons return home from work.

Accordingly, there is a need in the art for an electricity generation system with integrated load management for regulating the generation, storage, and provision of a supplemental supply of electricity from an energy storage system into the electricity distribution system to meet peaking demand for electricity. It is to such that the present invention is directed.

### BRIEF SUMMARY OF THE INVENTION

The present invention meets the need in the art by providing an electricity generation, transmission, and distribution system with integrated load management for supplying a supplemental electrical current to an electricity transmission and distribution grid for supply of electrical current to a plurality of load centers, comprising an electricity generating source that supplies alternating current electricity to an electricity transmission and distribution grid of a high voltage transmission network and a low voltage distribution network communicating electricity to a plurality of load centers each having a respective demand for electrical current; and an energy storage system for selective supply of a supplemental electrical current into the electricity transmission and distribution grid. The energy storage system comprises a supply of a heat transfer fluid (HTF) and a heater for heating the heat transfer fluid to a first temperature. A nozzle has an intake and an ejection port opposing the intake and an injection port intermediate the intake and the ejection port. A pump provides a flow of the HTF at a first temperature from the supply to the intake of the nozzle. An injector provides a flow of an injection liquid from a supply at a second temperature into the nozzle through the injection port. The first temperature is at or above a heat of vaporization temperature of the injection liquid, whereby heat transfer from the HTF to the injection liquid produces by phase change an IL gas, whereby the nozzle limiting a volume from proximate the injection port longitudinally to the ejection port, for thereby increasing a pressure of the IL gas therealong and for converting the heat of the HTF to kinetic energy to cause accelerating movement of the HTF and IL gas through the nozzle towards the ejection port for ejection for performing mechanical work. A turbine couples to the nozzle, wherein ejection of the IL gas and HTF through the ejection port of the nozzle results in rotation of the turbine by the kinetic energy of the ejected HTF. A generator operatively couples to the turbine for generating an electrical current. A current conditioner for conditioning the electrical current to alternating current electricity for communication as a supplemental alternating electric current to the electricity transmission and distribution grid. A local controller for controlling operation of the energy storage system, upon sensing a power supply status for the energy storage system to supply a supplemental electrical current to the electricity transmission and distribution grid and a load demand controller communicating a demand instruction to the local controller selectively for the local controller to supply alternating current electricity to the electricity transmission and distribution grid based on aggregated demand of the load centers for electricity and the power supply status of the energy storage system. The local controller manages generation of the electrical current by the energy storage system and the supply of conditioned alternating current based on the demand instruction from the load demand controller.

In another aspect, the electricity generation, transmission, and distribution system further comprises a plurality of solar photovoltaic modules for generation of direct current electricity upon exposure to ambient light, for operating the heater using the generated direct current electricity.

In a further aspect, the electricity generation, transmission, and distribution system comprising a battery bank for receiving and storing direct current electricity generated by the plurality of solar photovoltaic modules; and the local controller further configured for selective supply of the direct current electricity generated by the plurality of solar photovoltaic modules (i) to the heater, (ii) to the battery bank, or (ii) to the current conditioner for supply of alternating current electricity to the electricity transmission and distribution grid based on the demand instruction from the load demand controller.

The electricity generation, transmission, and distribution system further comprising a diverter for directing the direct current electricity generated by the plurality of solar photovoltaic modules selectively to (i) the heater, (ii) the battery bank, and (iii) the current conditioner based on communication from the local controller.

The electricity generation, transmission, and distribution system wherein the local controller further configured for selective supply of electric current from selectively one or more of the (i) solar photovoltaic modules, (ii) the battery bank, or (iii) the energy storage system, to the current conditioner for supply of alternating current electricity to the electricity transmission and distribution grid based on the demand instruction from the load demand controller.

In another aspect, the present invention provides a method of supplying a supplemental electrical current to an electricity transmission and distribution grid of an electricity generation, transmission, and distribution system servicing a plurality of load centers each with a respective demand for a supply of electricity, comprising the steps of:
(a) providing an electricity generating source that supplies alternating current electricity to an electricity transmission and distribution grid of a high voltage transmission network and a low voltage distribution network communicating electricity to a plurality of load centers each having a respective demand for electrical current;
(b) monitoring an aggregate demand of the load centers by a load demand controller;
(c) providing an energy storage system for supplying a supplemental electrical current to the electricity transmission and distribution grid to meet the aggregate demand, said supplying of the supplemental electrical current comprising the steps of:
   providing a flow of a heat transfer fluid (HTF) at a first temperature to an intake of a nozzle opposing an ejection port;
   injecting an injection liquid at a second temperature into the nozzle through the injection port intermediate the intake and the ejection port, said first temperature at or above a heat of vaporization temperature of the injection liquid, whereby heat transfer from the HTF to the injection liquid produces by phase change an IL gas;
   whereby the nozzle limiting a volume from proximate the injection port longitudinally to the ejection port, for thereby increasing a pressure of the IL gas therealong and for converting the heat of the HTF to kinetic energy to cause accelerating movement of the HTF and IL gas through the nozzle towards the ejection port for ejection for performing mechanical work;
   driving a turbine coupled to the nozzle by the ejection of the IL gas and HTF through the ejection port of the nozzle;
   generating a supply of electrical current by a generator coupled to the turbine,
   conditioning the generated electrical current to alternating current electricity for communication as a supplemental alternating electric current to the electricity transmission and distribution grid; and
   providing a local controller for controlling operation of the energy storage system, said local controller sensing a power supply status for the energy storage system to supply a supplemental electrical current to the electricity transmission and distribution grid; and
(d) communicating between the local controller and the load demand controller a power supply status of the energy storage system and a responsive demand instruction from the load demand controller for selectively supplying alternating current electricity from the energy storage system to the electricity transmission and distribution grid in response to the aggregated demand of the plurality of load centers,
whereby the local controller manages the energy storage system for the supply of conditioned alternating current based on the load demand instruction from the load demand controller.

The method further comprising the step of operating a heater using the electricity generated by a plurality of solar photovoltaic modules upon exposure to ambient light for heating the heat transfer fluid (HTF).

In a further aspect, the electricity generated by the plurality of solar photovoltaic modules selectively stored in a battery bank.

The method further comprising the step of configuring the local controller for selective supply of the electricity generated by the plurality of solar photovoltaic modules (i) to the heater, (ii) to the battery bank, or (ii) to the current conditioner for supply of alternating current electricity to the electricity transmission and distribution grid based on the demand instruction from the load demand controller.

In another aspect, the method further comprising the step of selective supplying of electric current from one or more of the (i) solar photovoltaic modules, (ii) the battery bank, or (iii) the energy storage system, to the current conditioner for supply of alternating current electricity to the electricity transmission and distribution grid based on the demand instruction from the load demand controller.

Objects, advantages, and features of the present invention will become readily apparent upon a reading of the following detailed description in conjunction with the drawings.

### BRIEF DESCRIPTION OF THE DRAWINGS

FIG. 1 illustrates a schematic diagram of a first embodiment of a solar-energy electricity generation system with an integrated load management for regulating the generation, storage, and providing a supply of electricity introduced into an electricity distribution system.

FIG. 2 illustrates a schematic diagram of a second embodiment of a solar-energy electricity generation system with an integrated load management for regulating the generation, storage, and providing a supply of the electricity introduced into an electricity transmission system.

FIG. 3 illustrates a schematic diagram of a third embodiment of a solar-energy electricity generation system with an energy storage system and operated by an integrated load management for regulating the generation, storage, and providing a supply of the electricity introduced into an electricity transmission system.

FIG. 4 illustrates a schematic diagram of an energy storage system illustrated in FIG. 3 in the another second embodiment of a solar-energy electricity generation system with an integrated load management for regulating the generation, storage, and providing a supply of the electricity introduced into an electricity transmission system.

### DETAILED DESCRIPTION

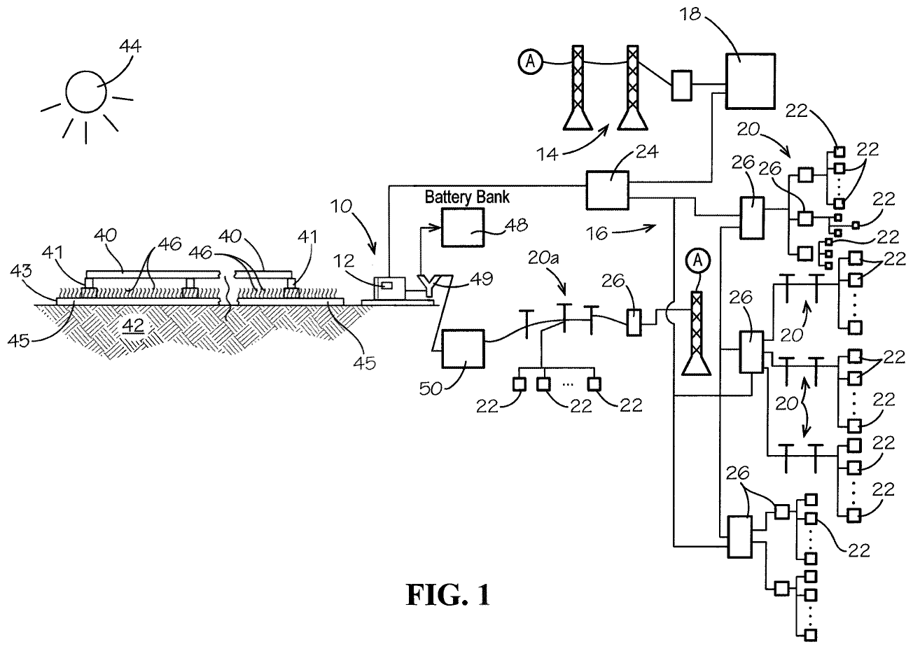

With reference to FIG. 1, the present invention provides a solar-energy electricity generation system 10 with an integrated load management controller 12 for regulating the generation, storage, and providing a supply of electricity introduced into an electricity distribution grid generally 16. FIG. 1 illustrates a first embodiment for supplemental supply of electrical current from the solar-energy electricity generation system 10 into an electricity transmission grid 14 of an integrated electric current supply system generally 16. The integrated electrical energy system 16 includes one or more electricity generation sources 10 and one or more main large capacity electricity generating plant 18. The electricity generating plant 18 (and at least one solar-energy electricity generation system 10) electrically connect to the electricity transmission grid 14 for delivery of electrical current to a plurality of electricity distribution grids 20 each providing electricity to a plurality of load centers 22 such as homes, schools, and businesses for operation of electrical devices, lighting, and machinery commonly in use today. A central operations center 24 communicates with the network of electricity sources and the transmission and distribution grids. The operations center 24 monitors demand from the plurality of load centers 22 and monitors the capacity and availability of the supply sources 10 and 18. The operations center 24 controls the supply operation of the electrical generation sources 10 and 18 and the transmission and distribution of electrical current as a supply for the demand for electricity by the load centers 22 across the power supply/usage grid 16 or network. Generally, the transmission grid 14 distributes high voltage electricity across long distances, as the electricity generation plants 18 are typically located remote from concentrated areas of load centers 22. The transmission grid 14 supplies the high voltage current to substations 26 that supply lower voltage electricity to the plurality of distribution grids 20 for serving the respective plurality of load centers 22.

The solar-energy electricity generation system 10 comprises a plurality of solar photovoltaic modules 40 that convert solar energy from the sun 44 into electrical current. The solar photovoltaic modules 40 are disposed as an array of spaced-apart modules that attach to supports 41 on a ground site 42. The illustrated system uses a woven tufted geosynthetic ground cover 43 having a woven geosynthetic sheet 45 tufted with a plurality of yarns that define tufts 46 of simulated grass. The ground cover 43 may include an impermeable geomembrane. The ground cover 43 simulates a field of grass while reducing or eliminating growth of natural plants and grasses that require maintenance.

The solar-energy electricity generation system 10 includes the local controller 12 that communicates with the operations center 24 as well as monitors the generation of electrical current by the solar photovoltaic modules 40. The local controller 12 comprises a microprocessor computer system with software instructions configured to carry out the monitoring and control of the solar photovoltaic modules 40. A battery bank 48 provides for local on-site storage of electricity generated by the plurality of solar photovoltaic modules 40. A diverter 49 operated by the local controller 12 directs the generated electricity selectively for storage in the battery bank 48 or to a current conditioner 50 for supply of the generated electricity to the electrical grid. The current conditioner 50 receives the direct current electricity from the plurality of solar photovoltaic modules 40, from the battery bank 48, or a combination of the two. The current conditioner 50 conditions the direct current electricity for supply into the electricity grid. In a first embodiment illustrated in FIG. 1, the current conditioner 50 conditions the electricity for supply as low voltage, alternating current for supply into the connected distribution grid 20a for supplemental power supply servicing its respective load centers 22.

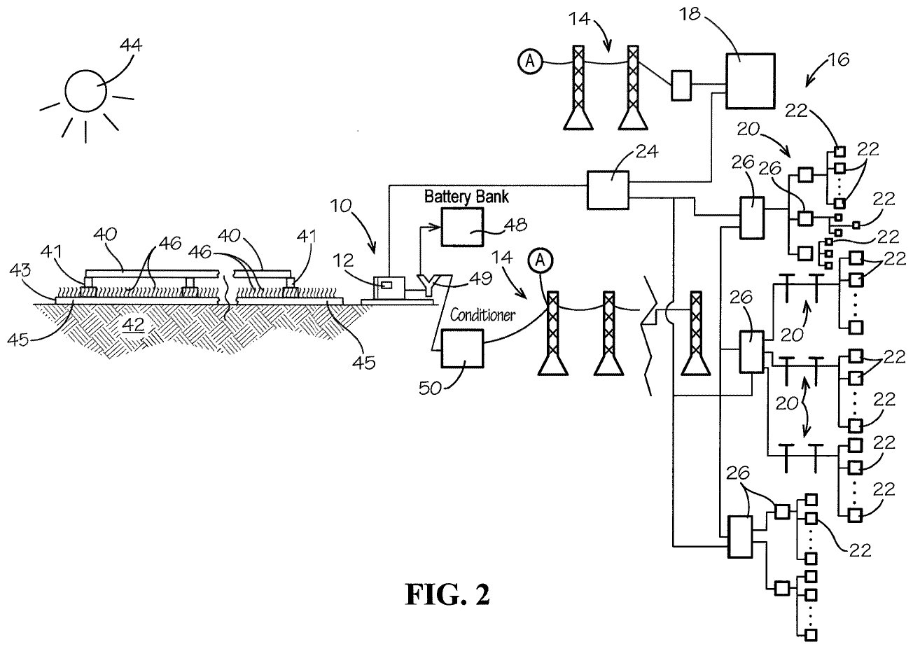

FIG. 2 illustrates in a schematic diagram a second embodiment of the solar-energy electricity generation system 10a with the integrated load management controller 12 for regulating the supply of the generated electricity introduced into the electricity transmission grid 14. In this embodiment, the current conditioner 50 conditions the direct current electricity to high voltage alternating current for supply into the transmission grid 14. The second embodiment preferably deploys as a supplemental power source at a conventional electricity generation plant 18. This enables the solar photovoltaic energy system 10a to gainfully use conventional interconnection equipment and substation invertors for converting from low voltage direct current to high voltage alternating current communicated through the transmission grid 14.

During operation of the solar-energy electricity generation system 10, the local controller 12 communicates with the operations center 24. The operations center 24 monitors demand from the distribution grids 20 for servicing the respective load centers 22. The operations center 24 directs the generation of electricity by the sources 10 and 18 for supply into the transmission grid 14 and distribution grids 20 for supply of electrical current. The operations center 24 balances the supply demand with generation plant 18 capacity and supplemental supply from the one or more of the solar-energy supply generation systems 10. During daylight generation of electricity by the solar-energy supply generation system 10, the local controller 12 manages the communication of the generated electricity into the battery bank 48 or into the electrical grid through the diverter 49. Alternatively, the controller 12 may manage delivery of generated electricity as a combination of momentarily generated electricity together with electricity from the battery bank 48. The local controller 12 manages the production of electricity based on requirements communicated by the operations center 24 in balancing electrical supply capacity with the electrical demand of the load centers 22.

Electricity generated by the solar photovoltaic modules 40 communicates through the diverter 49 selectively into the battery bank 48 for storage or into the electrical grid 14 after conditioning by the current conditioner 50. At night-time or overcast daytime, the operational controller 24 may direct the local photovoltaic system 10a to supply current from the battery bank 48. The local controller 12 causes the current to flow from the battery bank 48 through the diverter 49 into the current conditioner 50 for converting from direct current to alternating current for supply into the respective transmission grid 14 or distribution grid 20.

During operation, the operating controller 12 periodically communicates the power supply status of the solar photovoltaic system 10 to the central operations center 24. The power supply status includes the momentary power supply capacity of the photovoltaic modules 40, the energy storage held in the battery bank 48, and the power that may be provided into the electrical grid. The operations center 24 directs the controller 12 in managing the use of the generated electricity; for example, conditioning and supply of electricity into the electrical grid 16 (transmission grid 14 or distribution grid 20, as connected), transferring of the electricity into the battery bank 48, or a combination, based on electrical demand from load centers 22 serviced by the distribution networks 20 and supply of electricity generated by the at least one power generation plant 18 and the at least one supplemental solar photovoltaic energy generation system 10. The operations center 24 balances the demand and supply, and the load demand controller communicates supply instructions to the operating controller 12.

The operating controller 12 manages the supply of electricity from the solar energy generation system 10 (generated or supplied from battery 48) into the electrical grid based on the supply instruction. The involves the operating controller 12 balancing the current supplied into the electrical grid with the momentarily generated current of the solar generation system 10 and the current from the battery bank 48. The operating controller 12 adjusts the source of the supplied current using the as-generated current and the battery current, because the as-generated current may vary based on ambient atmosphere conditions of clouds and varying solar energy directed onto the solar photovoltaic modules.

The operating controller 12 reports, as noted above, the power supply status to the central operations center 24. The demand controller of the central operations center evaluates such power supply status from the one or more solar energy generation systems 10, and the power supply status communicated by the power generation plant 18, and other on-line or standby supplemental energy systems such as solar or other fuel source energy supply system, to balance electrical current supply with demand. The operations center 24 periodically communicates a responsive demand instruction to the operating controller 12, or other on-line operating controllers, for selectively supplying supplemental electrical current to the electrical grid.

The local load management controller 12 at each solar photovoltaic energy generation station 10 communicates with the electrical grid controller 24. The local load management controller 12 manages the electricity that is generated by the solar photovoltaic energy generation station 10. The load management controller 12 directs the generated electricity: (i) into the battery bank 48, (ii) into the electrical grid (14 or 20, as connected), or (iii) combination into the battery bank and the electrical grid. The load management controller 12 provides supplemental electricity into the electrical grid using: (i) power stored in the battery bank 48 or (ii) combination of electricity sourced from the battery bank 48 and the electricity generated with the solar photovoltaic modules 40, based on instructions for supply of electricity requested from the electrical grid controller 24.

In an exemplary embodiment, the load management controller 12 communicates the power supply status of the solar photovoltaic generation system 10 to the electrical grid controller 24. As noted above, the power supply status includes the momentary power supply capacity of the photovoltaic modules 40, the energy storage held in the battery bank 48, and the power that may be provided into the electrical grid. The electrical grid controller 24 uses this status information to assess supply for electricity available from the one or more solar photovoltaic energy generation systems 10 and the one or more power plants 18 within the electrical grid in view of demand from the load centers, and other standby electric current supplier available for servicing the grid demand for electrical current. The electrical grid controller 24 communicates with the load management controller 12 a confirmation of a load supply to be provided by the solar photovoltaic generation system 10. The load management controller 12 directs the generated electricity into the electrical grid and surplus energy if any is directed into the battery bank 48.

The deliverable capacity of the solar photovoltaic generation system may change based on changes in ambient conditions. The deliverable capacity may decrease, for example, by a cloud that passes over the generation site blocking or reducing solar radiation received by the solar photovoltaic modules 40 or the solar radiation angle changes as the earth rotates relative to the sun. These ambient changes may decrease the generation of electricity for supply to the electrical grid. The load management controller 12 however supplements the decreased generation of electricity (the instructed delivery amount less a reduction due to ambient changes) with electricity from the battery bank 48, so that the local site continues to feed the directed kilowatts into the electrical grid. The local load management controller 12 also communicates to the electrical grid controller 24 the status showing that the generation capacity of the solar energy generation system 10 is now reduced. As noted above, the status information includes the amount of generation capacity, the battery bank supply capacity, and the deliverable electricity. The electrical grid controller 24 receives the periodic power status information, and continually periodically evaluates the system capacity information from other of a plurality of solar photovoltaic generation systems 10 if integrated into the electrical grid and the power plants 18 that are on-line, and balances supply and sources of available capacity with demand from distribution grids 20 servicing the load centers 22.

Similarly, ambient changes may increase the generation capacity of the solar energy generation system 10, and to local load management controller 12 also communicates to the electrical grid controller 24 the status showing that the generation capacity is now increased. The local load management controller 12 manages the surplus generated electricity by directing the surplus into the battery bank 48 while continuing to supply the instructed capacity. The electrical grid controller 24 however receives the generation status of the solar photovoltaic system 10 and may in response increase the delivery requirement for the solar photovoltaic system 10 to meet load center demand.

The present invention gainfully may be deployed on large area ground sites such as closed landfills or lay-down waste sites at power plants, but compact systems may be readily deployed in small area sites (less than one acre or larger) for supplemental supply into the local transmission or distribution grid. Thus, more than one compact solar photovoltaic energy generation system may be installed in different areas and integrated with the electricity transmission and distribution system as disclosed herein for supply of electricity to meet demand from the plurality of load centers across the electric services grid.

The present invention accordingly provides a solar-energy electricity generation system with integrated load management for regulating the supply of the electricity introduced into the electricity distribution system. The solar-energy electricity generation system comprises:
a plurality of solar photovoltaic modules mounted in an array;
a battery bank for receiving and storing direct current electricity generated by the plurality of solar photovoltaic modules in response to exposure to ambient light;
a current conditioner for conditioning direct current to alternating current for communication to an electrical power supply grid;
a diverter for directing electricity generated by the plurality of solar photovoltaic modules selectively to the battery bank and to the current conditioner;
a local controller for selective storage of electricity generated by the plurality of solar photovoltaic modules in the battery bank or for supply of electricity from either the battery bank or at demand generation by the plurality of solar photovoltaic modules; and
a load demand controller communicating a demand instruction to the local controller selectively for the local controller to supply electrical current to an electrical grid,
whereby the local controller manages the generation, storage, and supply of electricity from the plurality of solar photovoltaic modules based on the demand instruction from the load demand controller.

In another aspect, the present invention provides a method of supplying supplemental electricity to an electrical grid using a solar-energy electricity generation system, comprising the steps of:
(a) mounting a plurality of solar photovoltaic modules in an array for exposure to ambient light;
(b) connecting a battery bank electrically to the array of the plurality of solar photovoltaic modules for receiving and storing direct current electricity generated by the plurality of solar photovoltaic modules in response to exposure to ambient light;
(c) selectively diverting the direct current electricity to the battery bank, to a current conditioner for conditioning the direct current electricity to an alternating current for supply into electrical power supply grid;
(d) providing a local controller for managing the generation and distribution of electricity generated by the plurality of solar photovoltaic modules for selective storage of the direct current electricity generated by the plurality of solar photovoltaic modules in the battery bank or for supply of electricity to an electrical grid said supply of electricity from the battery bank, from the on-demand generation of electricity by the plurality of solar photovoltaic modules, and from a combination of electricity from the battery bank and from the on-demand generation of electricity; and
(e) communicating between the local controller and a load demand controller a power supply status and a responsive demand instruction for selectively supplying electricity to the electrical grid,
whereby the local controller manages the generation, storage, and supply of electricity from the plurality of solar photovoltaic modules based on the demand instruction from the load demand controller.

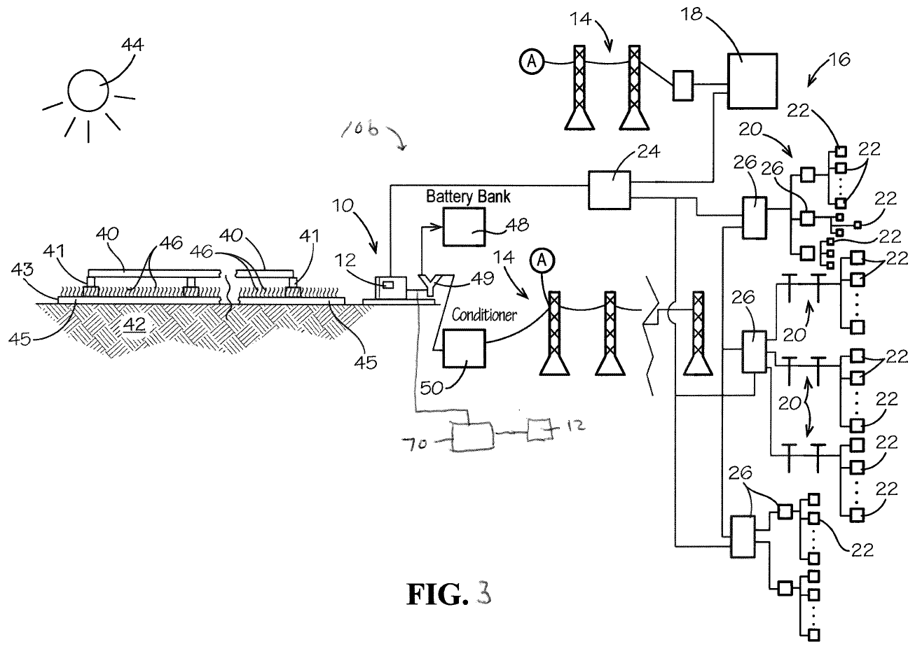

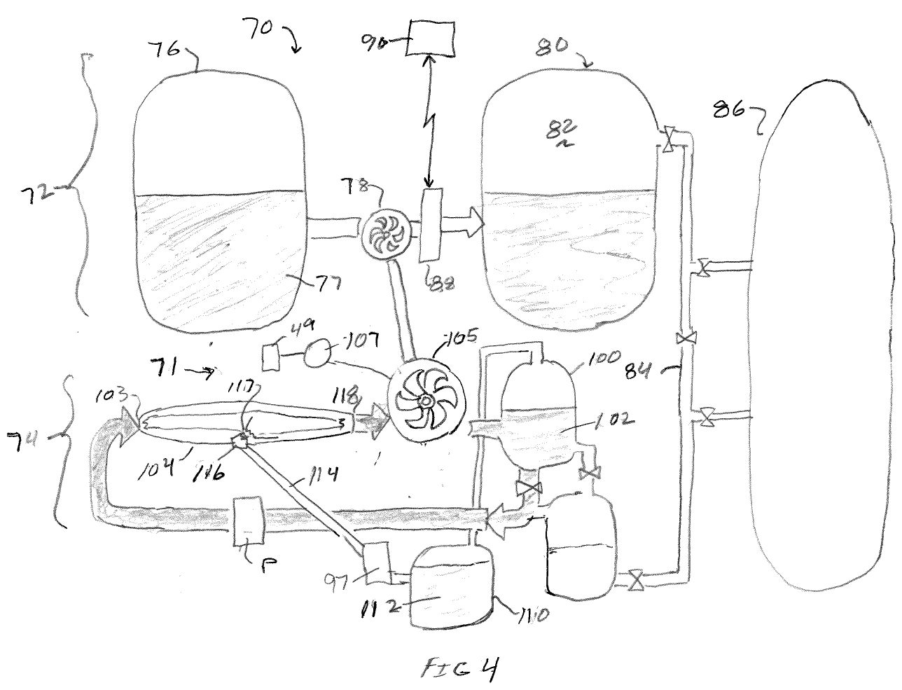

FIG. 3 illustrates in a schematic diagram a third embodiment of the solar-energy electricity generation system 10b having an energy storage system 70 for generation and supply of a supplemental alternating electrical current for being introduced to the transmission grid 14 through the diverter 49 and conditioner 50. An embodiment of the energy storage system 70 as further illustrated in detail in FIG. 4 discussed below. The energy storage system 70 in a preferred embodiment is configured in accordance with the system and method for converting heat to mechanical work as disclosed in Rotschild U.S. Pat. No. 11,927,117 B2 incorporated herein by reference in its entirety, for driving a turbine 105. The turbine 105 operated by the converted generated work couples to a generator 107 for generating electrical current. The integrated load management controller 12 regulates the supply of the generated electricity introduced into the electricity transmission grid 14 in response to the central controller 24 directing the supply of the supplemental current. As discussed above, the current conditioner 50 conditions the direct current electricity to high voltage alternating current for supply into the transmission grid 14. This enables the solar photovoltaic energy system 10b to gainfully use conventional interconnection equipment and substation invertors for converting from low voltage direct current to high voltage alternating current communicated through the transmission grid 14.

The third embodiment 10b preferably deploys with the energy storage system 70 as a peaker plant providing supplemental power source at a conventional electricity generation plant 18 for meeting a peak demand for electricity. Optionally, the third embodiment 10b further includes at least a plurality of solar photovoltaic modules 40 for generating electricity to be used for heating the heat transfer liquid used in the energy storage system 70. Alternatively, the third embodiment 10b includes both the energy storage system 70 and the solar energy generation system 10a discussed above as peaker plants, for advantageously benefiting from solar energy generation while using both the solar energy generation system 10a and the generator 105 driven by the energy storage system for responsive supply of supplemental alternating current to the aggregated demand of the load centers 22 supplied through the distribution grids 20 of the electrical transmission grid 14. The electricity generated by the solar energy generation system 10a may be gainfully used for heating the heat transfer liquid of the energy storage system 70, stored in the battery bank 46, or supplied through the conditioner 49 to the transmission grid and while the energy storage system 70 using the high temperature heat transfer liquid is responsive capably with the spinning generator generated electricity for peaker response to grid demands for increased supply of electrical current to meet aggregated demand of the plurality of load centers 22.

FIG. 4 illustrates a schematic diagram of an exemplary embodiment of an energy storage system 70 illustrated in the solar-energy electricity generation system 10b. The energy storage system 70 includes a heat engine 71 having a nozzle 104 that operates to convert heat to mechanical work. The heat engine 71 includes a heat generation/pressurization loop generally 72 and a heat/work loop generally 74. The two loops 72, 74 may be independent or may be coupled as a closed intra-communication system for generation of heat and for conversion of heat to mechanical work.

The heat generation/pressurization loop 72 in the exemplary embodiment provides a low-pressure chamber 76 having a supply of a pressurization fluid 77. The low-pressure chamber 76 may be at ambient pressure and temperature. The supply chamber 76 communicates the pressurization fluid through a pump 78 to a high-pressure pressurization vessel or chamber 80 at least partially filled with a supply of air 82. The chamber 80 communicates pressurized air through a valve/piping network 84 to a pressure storage chamber 86. In the illustrative embodiment, a heat exchanger 88 receives the pressure fluid flow from the pump 78. The heat exchanger 88 heats the flow of the pressurization fluid communicated to the high-pressure chamber 80. The heat exchanger 88 operates with a supply 90 of heat, such as a supply using a heat transfer fluid operated by an energy source, particularly, the solar energy generation system 10 for generating electricity or generating a heated fluid for use in the heat exchanger.

In an alternate embodiment, the pressurized air in the pressure storage chamber 86 may be communicated in a reverse direction back into the chamber 80 for driving a fluid-operative turbine (not shown) for generating electricity.

Further in reference to the heat engine 70, the heat/work loop 74 comprises a supply chamber 100 that contains a heat transfer liquid 102 at high temperature. For example, the heat transfer liquid 102 may be a molten salt at 850°K, a thermal oil at 700°K, or water under pressure at a temperature slightly below its boiling point. The supply chamber 100 communicates the heat transfer liquid 102 through an intake 103 of the nozzle 104 in accordance with the present invention for driving the turbine 105 to produce electricity by converting the flow to rotation of the generator 107 for generating electricity. A motivator drives the flow of the heat transfer liquid 102 to the intake port 103. In embodiments of the invention, the motivator may be a pump or in other embodiment may be a supply conduit receiving pressurized air from the supply 86. A heat exchanger may be used in some embodiments for optionally increasing the temperature of the heat exchange fluid. The heat exchanger may communicate with the heated pressurized air from the supply 86.

The heat/work loop 74 includes a chamber 110 having a supply of an injection liquid 112. The chamber 110 communicates through a supply pipe 114 that connects to an injection port 116. In the illustrated embodiment, the injection port 116 is intermediate the intake 103 and an ejection port 118 of the nozzle 104. An injector 117 communicates the injection fluid from the supply chamber 112 through the injection port 116 into the nozzle 104. The injector may be operated by a pump or may be a supply conduit from the storage chamber 86. The nozzle 104 limits a volume from proximate the injection port 116 longitudinally narrowing traversely to the ejection port 118. During operation of the illustrative embodiment, the heat of the HTF converts to kinetic energy by heat of vaporization causing a state change of the injection liquid IL from liquid to an IL gas. A pressure of the gas increases as the IL gas and HTF flow therealong in the nozzle 104 to the ejection port 118. The heat conversion causes accelerating movement of the HTF and IL gas through the nozzle 104 towards the ejection port 118 for ejection for mechanical work.

The turbine 105, in some embodiments, is chemically resistive and designed for the operating heat transfer liquid and temperature used as a hydro-electric turbine to produce electricity by converting flow to rotation to electricity. The turbine 105 is thereby connected to the supply chamber 100, and optionally to a separation chamber at a lower pressure, for example at ambient pressure for separation of the in situ generated gas and heat transfer liquid. The separation chamber communicates the separated gas to the injection liquid supply tank for condensing and mixing into the supply.

Useful devices for the turbine 105 include a Francis turbine, a Kaplan turbine, a Pelton wheel, a Tesla turbine and similar designs used for hydroelectric turbines, and in some embodiments use materials typically used for molten salt and/or high temperature thermal oil pumps.

Alternatively, the nozzle 104 may be static, whereby the ejected HTF can be coupled for a mechanical device for mechanical work.

In some embodiments, electricity generated by operation of the turbine 105 and generator 107 may be used to operate the pump 78 for flow of the fluid 77 for pressurization. Alternatively, in some embodiments, the turbine 105 is optionally connected by a shaft to the pump 78, either directly or by gears for controlling a flow rate from the pump. Work is produced when pressure at the supply chamber 80 increases, as the shaft drives the pump.

In reference to FIG. 3, the heat engine 70 operates for using heat energy for mechanical work with the supplied heat transfer fluid 102 and driven by the motivator for communicating the flow of the heat transfer fluid at the first temperature from the supply 102 to the intake 103 of the nozzle 104. The injector provides the injection fluid IL 112 at a second temperature through the injection port 116, which second temperature is less than the first temperature. The first temperature is at or above the heat of vaporization temperature of the injection liquid 112. Upon injection, heat transfers from the HTF 102 to the injection liquid 112 and produces by phase change an IL gas. The volume of the nozzle 104 limits the IL gas, and the heat transfer increases the pressure of the IL gas and creates kinetic energy causing acceleration of the flow of the IL gas and the HTF towards the ejection nozzle for mechanical work. In an embodiment, the nozzle 104 couples to the turbine 105. The accelerated HTF ejects from the nozzle 104 and causes rotation of the turbine 105 for mechanical work. In the illustrated embodiment, the turbine coupled to the generator 107 generates electrical current.

The load demand controller 24 communicating a demand instruction to the local controller 12 selectively for the local controller to supply alternating current electricity to the electricity transmission and distribution grid 14 based on aggregated demand of the load centers 22 for electricity and the power supply status of the energy storage system, whereby the local controller manages generation of the electrical current by the energy storage system 70 and the supply of conditioned alternating current based on the demand instruction from the load demand controller.

The electricity generation, transmission, and distribution system features integrated load management supplies supplemental electrical current to the electricity transmission and distribution grid 14 for supply of electrical current to the plurality of load centers 22 with the electricity generating source 18 that supplies alternating current electricity to the electricity transmission and distribution grid of the high voltage transmission network and a low voltage distribution network communicating electricity to the plurality of load centers 22 each having a respective demand for electrical current; supplemented by the energy storage system 10b for selective supply of supplemental electrical current into the electricity transmission and distribution grid. The energy storage system comprises the supply of the heat transfer fluid (HTF) 102 and a heater 82 for heating the heat transfer fluid to the first temperature. The nozzle 104 has the intake 103 and the ejection port 118 opposing the intake and the injection port 116 intermediate the intake and the ejection port. The pump provides the flow of the HTF at the first temperature from the supply 100 to the intake 103 of the nozzle. 104 The injector provides the flow of the injection liquid 102 from the supply 110 at the second temperature into the nozzle 104 through the injection port 116. The first temperature is at or above a heat of vaporization temperature of the injection liquid, whereby heat transfer from the HTF to the injection liquid produces by phase change an IL gas, whereby the nozzle limiting a volume from proximate the injection port longitudinally to the ejection port, for thereby increasing a pressure of the IL gas therealong and for converting the heat of the HTF to kinetic energy to cause accelerating movement of the HTF and IL gas through the nozzle towards the ejection port for ejection for performing mechanical work. The turbine 105 couples to the nozzle 104, wherein ejection of the IL gas and HTF through the ejection port 118 of the nozzle results in rotation of the turbine by the kinetic energy of the ejected HTF. The generator 107 operatively coupled to the turbine 105 for generating the electrical current for supplement to the grid or as discussed, for operating the heater 82 or storage in a battery bank 48. The current conditioner 50 conditions the electrical current to alternating current electricity for communication as the supplemental alternating electric current to the electricity transmission and distribution grid 14 The local controller 12 controls operation of the energy storage system 70, upon sensing a power supply status for the energy storage system to supply a supplemental electrical current to the electricity transmission and distribution grid and the load demand controller 24 communicating the supply demand instruction to the local controller 12 selectively for the local controller to supply alternating current electricity to the electricity transmission and distribution grid based on aggregated demand of the load centers 22 for electricity and the power supply status of the energy storage system. The local controller 12 manages generation of the electrical current by the energy storage system and the supply of conditioned alternating current based on the demand instruction from the load demand controller 24.

The electricity generation, transmission, and distribution system may further comprise the plurality of solar photovoltaic modules 40 for generation of direct current electricity upon exposure to ambient light, for operating the heater using the generated direct current electricity.

Alternatively, the electricity generation, transmission, and distribution system comprises the battery bank 48 for receiving and storing direct current electricity generated by the plurality of solar photovoltaic modules 40. The local controller 12 further configured for selective supply of the direct current electricity generated by the plurality of solar photovoltaic modules (i) to the heater 88, (ii) to the battery bank 48, or (ii) to the current conditioner 50 for supply of alternating current electricity to the electricity transmission and distribution grid based on the demand instruction from the load demand controller.

The diverter 49 directs the direct current electricity generated by the plurality of solar photovoltaic modules 40 selectively to (i) the heater, (ii) the battery bank, and (iii) the current conditioner based on communication from the local controller 12.

The local controller 12 of the electricity generation, transmission, and distribution system is further configured for selective supply of electric current from selectively one or more of the (i) solar photovoltaic modules 40, (ii) the battery bank 50, or (iii) the energy storage system 70, to the current conditioner 50 for supply of alternating current electricity to the electricity transmission and distribution grid 14 based on the demand instruction from the load demand controller 24.

The present invention supplies the supplemental electrical current to the electricity transmission and distribution grid 14 of an electricity generation, transmission, and distribution system servicing a plurality of load centers 22 each with a respective demand for a supply of electricity. The method steps comprise:
(a) providing the electricity generating source 18 that supplies alternating current electricity to the electricity transmission and distribution grid 14 of the high voltage transmission network and the low voltage distribution network communicating electricity to the plurality of load centers 22 each having a respective demand for electrical current;
(b) monitoring the aggregate demand of the load centers 22 by the load demand controller 24;
(c) providing the energy storage system 70 for supplying the supplemental electrical current to the electricity transmission and distribution grid 14 to meet the aggregate demand. The method steps are providing the flow of the heat transfer fluid (HTF) 102 at the first temperature to the intake of the nozzle 104 opposing the ejection port 118; injecting the injection liquid 112 at the second temperature into the nozzle 104 through the injection port 116 intermediate the intake and the ejection port, with the first temperature at or above the heat of vaporization temperature of the injection liquid, whereby heat transfer from the HTF to the injection liquid produces by phase change an IL gas. The nozzle 104 limiting a volume from proximate the injection port longitudinally to the ejection port, for thereby increasing the pressure of the IL gas therealong and for converting the heat of the HTF to kinetic energy to cause accelerating movement of the HTF and IL gas through the nozzle towards the ejection port for ejection for performing mechanical work. This drives the turbine 105 that is coupled to the nozzle. The generator 107 coupled to the turbine 105 generates the supply of electrical current that, upon conditioning is supplied as supplemental alternating current electricity to the electricity transmission and distribution grid 14. The local controller 12 controls operation of the energy storage system, for sensing the power supply status for the energy storage system to supply the supplemental electrical current to the electricity transmission and distribution grid. Upon communicating between the local controller 12 and the load demand controller 24 the power supply status of the energy storage system and a responsive demand instruction from the load demand controller 24 selectively supplying alternating current electricity from the energy storage system to the electricity transmission and distribution grid in response to the aggregated demand of the plurality of load centers, whereby the local controller manages the energy storage system for the supply of conditioned alternating current based on the load demand instruction from the load demand controller.

The method further comprises operating the heater using the electricity generated by the plurality of solar photovoltaic modules 40 upon exposure to ambient light for heating the heat transfer fluid (HTF).

In a further aspect, the electricity generated by the plurality of solar photovoltaic modules selectively is stored in the battery bank. The method then uses the local controller configured for selective supply of the electricity generated by the plurality of solar photovoltaic modules (i) to the heater, (ii) to the battery bank, or (ii) to the current conditioner for supply of alternating current electricity to the electricity transmission and distribution grid based on the demand instruction from the load demand controller.

Further, the method comprising the step of selective supplying of electric current from one or more of the (i) solar photovoltaic modules, (ii) the battery bank, or (iii) the energy storage system, to the current conditioner for supply of alternating current electricity to the electricity transmission and distribution grid based on the demand instruction from the load demand controller.

The foregoing has disclosed operative embodiments of supplemental energy generation systems operated with a local controller that communicates with an integrated load demand controller for managing the generation, storage, and provision of a supply of electrical current into the electrical grid servicing load centers through transmission and distribution grids. An embodiment provides a supplemental energy generation system using solar photovoltaic modules while another embodiment uses an energy storage system and alternatively with solar photovoltaic modules for heating the process fluid in the energy storage system, for storage in a battery bank, and for supply to the electrical supply transmission and distribution grid operated by the local controller in response to the demand required by the load demand controller. While this invention has been described with particular reference to certain embodiments, one of ordinary skill may readily appreciate that variations and modifications can be made without departing from the spirit and scope of the invention as recited in the appended claims.

What is claimed is:

1. An electricity generation, transmission, and distribution system with integrated load management for supplying a supplemental electrical current to an electricity transmission and distribution grid for supply of electrical current to a plurality of load centers, comprising:
an electricity generating source that supplies alternating current electricity to an electricity transmission and distribution grid of a high voltage transmission network and a low voltage distribution network communicating electricity to a plurality of load centers each having a respective demand for electrical current; and
an energy storage system for selective supply of a supplemental electrical current into the electricity transmission and distribution grid, comprising:
a supply of a heat transfer fluid (HTF);
a heater for heating the heat transfer fluid to a first temperature;
a nozzle having an intake and an ejection port opposing the intake and an injection port intermediate the intake and the ejection port;
a pump for providing a flow of the HTF at a first temperature from the supply to the intake of the nozzle;
a supply of an injection liquid;
an injector for providing a flow of the injection liquid at a second temperature into the nozzle through the injection port, said first temperature at or above a heat of vaporization temperature of the injection liquid, whereby heat transfer from the HTF to the injection liquid produces by phase change an IL gas;
whereby the nozzle limiting a volume from proximate the injection port longitudinally to the ejection port, for thereby increasing a pressure of the IL gas therealong and for converting the heat of the HTF to kinetic energy to cause accelerating movement of the HTF and IL gas through the nozzle towards the ejection port for ejection for performing mechanical work;
a turbine coupled to the nozzle, wherein ejection of the IL gas and HTF through the ejection port of the nozzle results in rotation of the turbine by the kinetic energy of the ejected HTF;
a generator operatively coupled to the turbine for generating an electrical current;
a current conditioner for conditioning the electrical current to alternating current electricity for communication as a supplemental alternating electric current to the electricity transmission and distribution grid; and
a local controller for controlling operation of the energy storage system, said local controller sensing a power supply status for the energy storage system to supply a supplemental electrical current to the electricity transmission and distribution grid; and
a load demand controller communicating a demand instruction to the local controller selectively for the local controller to supply alternating current electricity to the electricity transmission and distribution grid based on aggregated demand of the load centers for electricity and the power supply status of the energy storage system,
whereby the local controller manages generation of the electrical current by the energy storage system and the supply of conditioned alternating current based on the demand instruction from the load demand controller.

2. The electricity generation, transmission, and distribution system as recited in claim 1, further comprising a plurality of solar photovoltaic modules for generation of direct current electricity upon exposure to ambient light, for operating the heater using the generated direct current electricity.

3. The electricity generation, transmission, and distribution system as recited in claim 2, further comprising a battery bank for receiving and storing direct current electricity generated by the plurality of solar photovoltaic modules; and
the local controller further configured for selective supply of the direct current electricity generated by the plurality of solar photovoltaic modules (i) to the heater, (ii) to the battery bank, or (ii) to the current conditioner for supply of alternating current electricity to the electricity transmission and distribution grid based on the demand instruction from the load demand controller.

4. The electricity generation, transmission, and distribution system as recited in claim 3, further comprising a diverter for directing the direct current electricity generated by the plurality of solar photovoltaic modules selectively to (i) the heater, (ii) the battery bank, and (iii) the current conditioner based on communication from the local controller.

5. The electricity generation, transmission, and distribution system as recited in claim 3, wherein the local controller further configured for selective supply of electric current from selectively one or more of the (i) solar photovoltaic modules, (ii) the battery bank, or (iii) the energy storage system, to the current conditioner for supply of alternating current electricity to the electricity transmission and distribution grid based on the demand instruction from the load demand controller.

6. A method of supplying a supplemental electrical current to an electricity transmission and distribution grid of an electricity generation, transmission, and distribution system servicing a plurality of load centers each with a respective demand for a supply of electricity, comprising the steps of:
(a) providing an electricity generating source that supplies alternating current electricity to an electricity transmission and distribution grid of a high voltage transmission network and a low voltage distribution network communicating electricity to a plurality of load centers each having a respective demand for electrical current;
(b) monitoring an aggregate demand of the load centers by a load demand controller;
(c) providing an energy storage system for supplying a supplemental electrical current to the electricity transmission and distribution grid to meet the aggregate demand, said supplying of the supplemental electrical current comprising the steps of:
providing a flow of a heat transfer fluid (HTF) at a first temperature to an intake of a nozzle opposing an ejection port;
injecting an injection liquid at a second temperature into the nozzle through the injection port intermediate the intake and the ejection port, said first temperature at or above a heat of vaporization temperature of the injection liquid, whereby heat transfer from the HTF to the injection liquid produces by phase change an IL gas;
whereby the nozzle limiting a volume from proximate the injection port longitudinally to the ejection port, for thereby increasing a pressure of the IL gas therealong and for converting the heat of the HTF to kinetic energy to cause accelerating movement of the HTF and IL gas through the nozzle towards the ejection port for ejection for performing mechanical work;
driving a turbine coupled to the nozzle by the ejection of the IL gas and HTF through the ejection port of the nozzle;
generating a supply of electrical current by a generator coupled to the turbine,
conditioning the generated electrical current to alternating current electricity for communication as a supplemental alternating electric current to the electricity transmission and distribution grid; and
providing a local controller for controlling operation of the energy storage system, said local controller sensing a power supply status for the energy storage system to supply a supplemental electrical current to the electricity transmission and distribution grid; and
(d) communicating between the local controller and the load demand controller a power supply status of the energy storage system and a responsive demand instruction from the load demand controller for selectively supplying alternating current electricity from the energy storage system to the electricity transmission and distribution grid in response to the aggregated demand of the plurality of load centers,
whereby the local controller manages the energy storage system for the supply of conditioned alternating current based on the load demand instruction from the load demand controller.

7. The method as recited in claim 6, further comprising a heater for heating the heat transfer fluid (HTF); and a plurality of solar photovoltaic modules for generation of electricity upon exposure to ambient light; and further comprising the step of operating the heater using the generated electricity.

8. The method as recited in claim 7, further comprising a holding vessel for holding a supply of the heat transfer fluid, wherein the heat transfer fluid (HTF) flows from the supply to the intake of the nozzle.

9. The method as recited in claim 7, further comprising the step of supplying the electricity generated by the plurality of solar photovoltaic modules to a battery bank.

10. The method as recited in claim 9, further comprising the step of configuring the local controller for selective supply of the electricity generated by the plurality of solar photovoltaic modules (i) to the heater, (ii) to the battery bank, or (ii) to the current conditioner for supply of alternating current electricity to the electricity transmission and distribution grid based on the demand instruction from the load demand controller.

11. The method as recited in claim 9, further comprising the step of selective supplying of electric current from one or more of the (i) solar photovoltaic modules, (ii) the battery bank, or (iii) the energy storage system, to the current conditioner for supply of alternating current electricity to the electricity transmission and distribution grid based on the demand instruction from the load demand controller.
